(19) United States
(12) Patent Application Publication
(10) Pub. No.: US 2009/0294230 A1
(43) Pub. Date: Dec. 3, 2009

(54) HYDRAULIC VIBRATION DAMPER

(76) Inventor: Claus Weimann, Wetter (DE)

Correspondence Address: COLLARD & ROE, P.C., 1077 NORTHERN BOULEVARD, ROSLYN, NY, 11576, US

(21) Appl. No.: 12/011,912

(22) Filed: Jan. 30, 2008

(30) Foreign Application Priority Data
Feb. 2, 2007 (DE) DE 102007005288.1

(51) Int. Cl. F16F 9/34; F16F 9/46

(52) U.S. Cl. 188/266.6

(57) ABSTRACT

A hydraulic vibration damper has a cylinder that is filled with a damping medium, displaceably accommodates a working piston disposed on a piston rod, through which the damping medium can flow, and is divided by the piston into two chambers. There is an equalization chamber that is connected with the working chamber, a pressure channel connected with the chamber on the piston rod side, and a controllable setting valve module connected with the pressure channel and the equalization chamber. The setting valve module has a pilot valve arrangement having a pilot pressure chamber and a pilot valve. The pilot pressure chamber is hydraulically separated from the main valve, and is connected with a valve chamber by a connection channel and at least one throttle point. A pressure element counteracts opening of the main valve, and pressure that acts on the main valve can be varied by the pilot valve.

### CROSS REFERENCE TO RELATED APPLICATIONS

Applicant claims priority under 35 U.S.C. §119 of German Application No. 10 2007 005 288.1 filed Feb. 2, 2007.

### BACKGROUND OF THE INVENTION

1. Field of the Invention

The invention relates to a hydraulic vibration damper, particularly for motor vehicles, having a cylinder that is filled with a damping medium, displaceably accommodates a working piston disposed on a piston rod, through which piston the damping medium can flow, and is divided, by the working piston, into a chamber on the piston rod side and a chamber away from the piston rod side. There is an equalization chamber that is connected with the chamber away from the piston rod side, by way of a bottom valve, and a pressure channel connected with the chamber on the piston rod side. There is a controllable setting valve module, which is connected with the pressure channel by an inflow opening and with the equalization chamber by an outflow opening. here is a valve chamber on the inflow side, as well as a valve chamber on the outflow side, which are separated by a main valve.

The setting valve module has a pilot valve arrangement for controlling the main valve, having a pilot pressure chamber and a pilot valve. The pilot pressure chamber is hydraulically separated from the main valves that open in the outflow direction, and connected with the valve chamber on the inflow side by way of a connection channel and at least one throttle point. A pressure element to which pressure is applied by the pilot pressure chamber counteracts the opening movement of the main valve. The pressure that acts on the main valve by way of the pressure element can be controlled by means of the pilot valve.

2. The Prior Art

A hydraulic vibration damper having the characteristics described initially is described in U.S. Pat. No. 5,282,645. The pilot valve consists of an electromagnetic valve that is disposed in a flow channel hydraulically connected with the pilot pressure chamber. A bypass flow that is passed past the main valve is produced by opening the electromagnetic valve, whereby at the same time, the pressure in the pilot pressure chamber is lowered, and the damping characteristics are changed, by way of the hydraulic connection to the pilot pressure chamber. In operation, the electromagnetic valve is exposed to a great pressure difference, and must be designed for a great holding force. Not only is there a great power requirement, but precise setting movements between the open and closed position are not possible, due to the design. It is a further disadvantage that the electromagnetic valve is open in the non-powered state, and as a result, soft damping occurs. In the case of a power failure, the soft damping of the vibration damper that then occurs can have unsafe driving behavior as a consequence.

A setting valve module for a hydraulic vibration damper is described in German Patent No. DE 197 22 216 C2, which damper also always has flow passing through it in the same flow direction, both during a pulling movement of the piston rod, directed outward, and during a pressing movement of the piston rod, directed inward. During movements of the working piston, the damping fluid flows out of a working chamber on the piston rod side into a pressure channel connected to the chamber on the piston side, flows through the setting valve module, and enters into an equalization chamber of the vibration damper, which damper is hydraulically connected with the working chamber away from the piston rod side. The setting valve module has a blocking valve body that is directly impacted by a spring, and the valve chamber on the inflow side, on the one side of the blocking valve body, is connected with the pilot pressure chamber by way of a bore as the throttle point. A pilot valve disposed on a slide is connected with the pilot pressure chamber. When the pilot valve opens, the pressure in the pilot chamber drops, so that the main valve is opened at a slight excess pressure. An electromagnet arrangement is provided to control the position of the pilot valve. It is true that the pilot valve allows an adjustment of the damping characteristics, but beyond that, the properties of the setting valve module, for example the dynamic behavior of the main valve during opening and closing movements, the functional relationship between the pressure in the pilot valve chamber and the flow-through rate, or also the maximal flow-through that can be achieved, are established on the basis of the design. An adaptation to different application cases, for example use in different motor vehicles, requires complicated changes in the design of the setting valve module.

A setting valve module for a hydraulic vibration damper is described in German Patent No. DE 195 18 560 C2, which has separate main valves for piston movements in the pulling and pressing direction. A pilot valve arrangement is provided for controlling the main valves, which arrangement comprises a pilot valve and pilot pressure chambers assigned to the main valves. The pilot pressure chambers are hydraulically separated from the main valve, which opens in the outflow direction, in each instance, and connected with the valve chamber on the inflow side by way of a connection channel as well as at least one throttle point. A pressure element to which pressure is applied by the pilot chamber counteracts the opening movement of the main valve, in each instance. The pressure that acts on the main valve by way of the pressure element can be controlled by means of the pilot valve, in the two pilot pressure chambers. The pilot valve is configured as a rotary slide. The setting valve module is complicated in terms of its design. It is a further disadvantage that the damping force is not defined, if, for example, a rotary drive that acts on the pilot valve fails due to a power failure. In the end result, in the case of a technical defect of the rotary drive that acts on the pilot valve, an overly soft damping force of the vibration damper, and therefore unsafe driving behavior of the vehicle can result.

### SUMMARY OF THE INVENTION

With this background, it is therefore an object of the invention to provide a controllable vibration damper that has a simple design and can easily be adapted to different application cases, guarantees great damping force and therefore safe driving behavior of the vehicle equipped with the vibration damper, in case of a power failure. This object is achieved by a hydraulic vibration damper, particularly for motor vehicles, having a cylinder that is filled with a damping medium, displaceably accommodates a working piston disposed on a piston rod, through which piston the damping medium can flow, and is divided, by the working piston, into a chamber on the piston rod side and a chamber away from the piston rod side.

There is an equalization chamber that is connected with the working chamber away from the piston rod side, by way of a bottom valve, a pressure channel connected with the chamber on the piston rod side, and a controllable setting valve module, which is connected with the pressure channel by an inflow opening and with the equalization chamber by an outflow opening, and has a valve chamber on the inflow side, as well as a valve chamber on the outflow side, which are separated by means of a main valve. The setting valve module has a pilot valve arrangement for controlling the main valve, having a pilot pressure chamber and a pilot valve. The pilot pressure chamber is hydraulically separated from the main valve that opens in the outflow direction, and connected with the valve chamber on the inflow side by way of a connection channel and at least one throttle point. A pressure element to which pressure is applied by the pilot pressure chamber counteracts the opening movement of the main valve, and the pressure that acts on the main valve by way of the pressure element can be controlled by means of the pilot valve.

The valve chamber on the inflow side and the valve chamber on the outflow side are disposed around a slide housing in which a slide changing the flow cross-section of a pilot valve opening of the pilot valve is disposed to move longitudinally. A fluid chamber is formed between the slide and the slide housing, which chamber hydraulically connects the valve chamber on the inflow side with the pilot pressure chamber, and the slide has inflow and outflow openings on the mantle side, as well as a passage channel. The passage channel is open at its faces, for the purpose of pressure equalization. A plunger coil arrangement is assigned to the slide as an actuator, and the setting movement of the slide takes place counter to the force of a slide spring. The pilot valve is closed in the non-powered state of the plunger coil arrangement.

According to the invention, the valve chamber on the inflow side and the valve chamber on the outflow side are disposed around a slide housing in which a slide for controlling the pilot valve is disposed to move longitudinally. A fluid chamber is formed between the slide and the slide housing, which chamber hydraulically connects the valve chamber on the inflow side with the pilot pressure chamber. The slide has inflow and outflow openings on the mantle side, as well as a passage channel, and the passage channel is open at its faces, for the purpose of equalization of the pressure forces that act on the slide. A plunger coil arrangement is assigned in the slide as an actuator, and the setting movement of the slide takes place counter to the force of a slide spring, and the pilot valve is closed in the non-powered state of the plunger coil arrangement.

According to the invention, the pressure prevailing in the pilot pressure chamber acts on a valve element of the main valve not directly, but by way of the pressure element, thereby making it possible to vary the hydraulically active surfaces for the opening and closing forces, independently of one another, to a great extent, in a particularly simple manner, when designing the vibration damper. The vibration damper is designed as a so-called pump-over system such that the setting valve module always has flow passing through it only in one direction, from the inflow opening to the outflow opening, because of the different flow-through resistance values of bottom valve and working piston and the volume change as the piston rod moves in and out.

The setting valve module can easily be joined together from individual parts, and appropriately adapted to the requirements by means of interchanging standardized parts, so that a desired damping characteristic is obtained. The slide can be displaced using extremely slight setting forces, so that a correspondingly weak configuration of the actuator is sufficient for changing the slide position, and a plunger coil arrangement can be used that is characterized by comparatively low power consumption, a low construction height, good controllability, and a low tendency to friction wear. In the non-powered state of the plunger coil arrangement, the pilot valve is moved into an emergency position by the slide spring, in which the pilot valve is closed. In the emergency position, a hard damping characteristic therefore occurs, which guarantees safe driving behavior.

The plunger coil arrangement has a permanent magnet attached to the housing of the setting valve module, as well as a plunger coil, whereby the plunger coil is preferably directly connected with one end of the slide, by way of a coil carrier.

It is practical if the slide is guided in the slide housing on a guide segment on the inflow side and a guide segment on the outflow side, whereby the inflow openings on the mantle side are disposed between the guide segments, and the guide segment on the outflow side interacts with the pilot valve opening and forms a part of the pilot valve.

The pressure element can be configured as a ring piston, which is displaceably guided on its outer circumference and its inner circumference, and sealed. The ring piston can slide freely in the pilot pressure chamber, as a pressure element, as a function of the pressure in the pilot pressure chamber and the force acting on the pressure element by way of the main valve. In this connection, the ring piston is preferably formed from a rigid material that is stable in shape. In an alternative embodiment, the pressure element is elastically movable about a fixed clamp, at its inner circumference, and displaceably guided at its outer circumference, and sealed. The pressure element can also be structured as a rubberized spring disk with integrated sealing elements on the inside and outside, for example.

The pressure element can act on the main valve, i.e. the valve element of the main valve, in a planar manner. In a preferred embodiment of the invention, the pressure element has at least one supporting edge or a supporting section, in order to guarantee a defined introduction of force from the pressure element to the main valve. Arranging a supporting edge or a supporting section on the pressure element is particularly advantageous in the case of an elastic configuration of the valve element of the main valve, for example a spring disk arrangement. Further possibilities for precisely adjusting the opening and closing behavior as well as the pressure-dependent progression of the flow-through rate result from the shape, the radial arrangement, and the progression of the at least one supporting edge or at least one supporting section. In particular, arranging at least one supporting edge or at least one supporting section guarantees a clearly defined and reproducible behavior of the main valve.

The characteristics of the pilot valve can be freely selected, to a great extent, within the scope of the invention. For example, when the pilot valve is configured as a slide valve disposed in a slide housing, the slide control edge can have a contour. Additionally or alternatively, the valve openings in the slide housing can be structured as crosswise or longitudinal slits having different width and/or length. It is also possible to arrange individual bores along the setting path of the slide valve, thereby making an essentially step-by-step adjustment possible. The characteristics of the pilot valve can be precisely adjusted by means of the measures described, particularly in the case of small volume flows.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a hydraulic vibration damper having a controllable setting valve module;

FIG. 2 shows a detail view of the setting valve module in a cross-sectional representation;

FIG. 3 shows an alternative embodiment of the setting valve module; and

FIG. 4 shows another alternative embodiment of a pilot valve chamber with a pressure element of the setting valve module.

### DETAILED DESCRIPTION OF THE PREFERRED EMBODIMENT

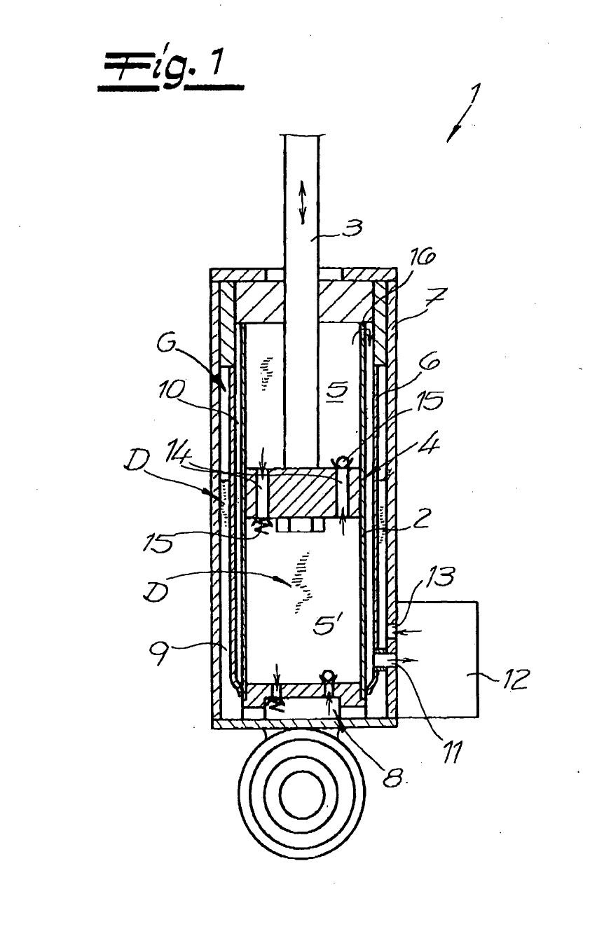

Referring now in detail to the drawings, FIG. 1 shows the structure of the vibration damper 1 according to the invention, having a cylinder 2 that is filled with a damping medium D, displaceably accommodates a working piston 4 disposed on a piston rod 3, through which piston damping medium D can flow, and is divided, by working piston 4, into a chamber 5 on the piston rod side and a chamber 5′ away from the piston rod side. Cylinder 2 is formed by an inner pipe that is surrounded by a center pipe 6 and an outer pipe 7. Chamber 5′ away from the piston rod side is connected with an equalization chamber 9 by way of a bottom valve 8 on cylinder 2, which chamber is formed between outer pipe 7 and center pipe 6. Equalization chamber 9 has a compressed gas G applied to it, and allows equalization of the volume in cylinder 2 that varies with the in and out movement of piston rod 3. Chamber 5 on the piston rod side is connected with inflow opening 11 of a controllable setting valve module 12 by way of a pressure channel 10 formed between the inner pipe and center pipe 6. An outflow opening 13 of setting valve module 12 is connected with equalization chamber 9. In the case of a pulling movement (pulling stage) on piston rod 3, the pressure in chamber 5 on the piston rod side is increased, and in chamber 5′ away from the piston rod side it is reduced, so that damping medium D flows through a channel 14 and a valve element 15 of working piston 4, for pressure equalization. If setting valve module 12 is at least partially open, part of damping medium D can also flow through a bore 16, pressure channel 10, and setting valve module 12, into equalization chamber 9, thereby achieving a reduction in the damping force of vibration damper 1, in total. In the case of a pressing movement, the pressure in chamber 5′ away from the piston rod is increased, whereby, however, the volume in cylinder 2 that is available for damping medium D is reduced, in total, due to piston rod 3 being pushed in. Since the flow-through resistance of working piston 4 is less than that of bottom valve 8, the pressure in chamber 5 on the piston rod side also increases in the case of a pressing movement (pressing stage). If setting valve module 12 is at least partially open, part of damping medium D can flow off through pressure channel 10 even during the pressing stage. The damping characteristics for the pulling stage and the pressing stage can be precisely adjusted by means of flow-through control at the setting valve module 12.

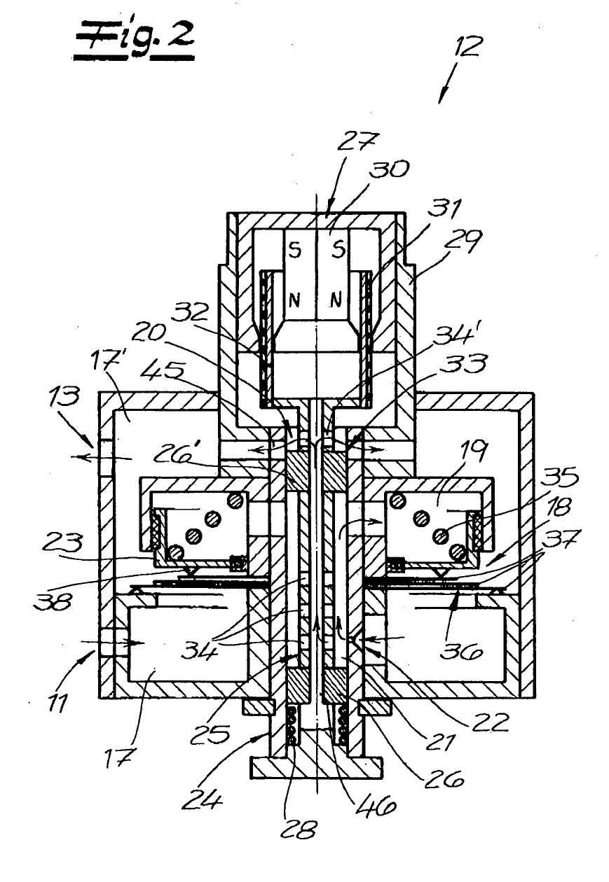

FIG. 2 shows the structure of setting valve module 12 in a sectional representation. Setting valve module 12 has a valve chamber 17 on the inflow side and a valve chamber 17′ on the outflow side, which are separated by a main valve 18. Main valve 18 can be controlled by a pilot valve arrangement having a pilot pressure chamber 19 and a pilot valve 20. Pilot pressure chamber 19 is hydraulically separated from main valve 18, which opens in the outflow direction, and connected with valve chamber 17 on the inflow side by way of a connection channel 21 and at least one throttle point 22. A pressure element 23 is disposed on pilot pressure chamber 19. In this connection, the hydraulic pressure that prevails in pilot pressure chamber 19 acts counter to the opening movement of main valve 18, by way of the pressure element 23, and pressure in pilot pressure chamber 19 can be controlled by pilot valve 20. Pilot valve module 12 connected laterally to outer pipe 7 is structured to be essentially cylindrical, except for flow-through bores and connection openings, and valve chamber 17 on the inflow side and valve chamber 17′ on the outflow side are disposed around a slide housing 24 in which a slide 25 is guided to move longitudinally, to control pilot valve 20. Slide 25 has a guide segment 26 on the inflow side and a guide segment 26′ on the outflow side. Guide segment 26′ on the outflow side also forms part of pilot valve 20, which is structured as a slide valve.

Connection channel 21 follows throttle point 22, in slide housing 24, which channel leads to pilot pressure chamber 19 and has a large cross-section as compared with throttle point 22. Connection channel 21 is not closed in any position of slide 25, whereby because of the large cross-section of connection channel 21, approximately the same pressure is always present within slide housing 24 and pilot pressure chamber 19. The slide 25 that can move longitudinally to control pilot valve 20 can be adjusted counter to the force of a slide spring 28, with a plunger coil arrangement 27 as the actuator. Plunger coil arrangement 27 has a permanent magnet 30 attached to a housing 29 of setting valve module 12, and a plunger coil 31, which is directly connected with slide 25 by way of a coil carrier 32. Additional mounting of the actuator, configured as a plunger coil arrangement 27, is not necessary, and tilting of slide 25 or of plunger coil 31 can also be prevented. When there is no current to plunger coil 31, slide 25 is moved into an emergency position by slide spring 28, and pilot valve 20 is closed completely or at least to a great extent. Slide 25 has a plurality of inflow and outflow openings 34, 34′ on the mantle side, as well as a passage channel 46 that is open at its faces. As a result of this configuration of slide 25, pressure equalization between the various sections of slide 25 is guaranteed when pilot valve 20 is closed. Because of the pressure equalization on all sides of slide 25 and in the housing of the actuator, no hydraulic difference forces act on slide 25 and coil carrier 32 connected with it, so that biased seals, which lead to increased friction, are not necessary. Because of the pressure equalization and the low friction at guides 26, 26′, small actuators having a low power consumption and great dynamics can be used.

If pilot valve 20 is closed, the same pressure prevails in valve chamber 17 on the inflow side as in pilot pressure chamber 19, in which a valve spring 35 is also disposed. Valve spring 35 counteracts the opening movement of main valve 18, together with the pressure prevailing in pilot pressure chamber 19, so that main valve 18 is closed, at least at usual pressure. However, setting valve module 12 can be designed in such a manner that main valve 18 can open even if pilot valve 20 is closed, at pressure peaks. The difference pressure at which main valve 18 opens, and the pressure-dependent flow-through rate, can be precisely adjusted by means of the opening position of pilot valve 20. In the embodiment shown in FIG. 2, main valve 18 has a spring disk arrangement having three spring disks 37 as the valve element 36. The characteristics of main valve 18 for different opening and pressure ranges can be precisely adjusted by combining different spring disks 37.

According to FIG. 2, pressure element 23 is configured as a ring piston, which is displaceably guided on its outer circumference and its inner circumference, and sealed. Pressure element 23 acts on the spring disk arrangement of main valve 18, by way of a circumferential supporting edge 38, thereby guaranteeing a defined introduction of force. A variation of the shape and arrangement of supporting edge 38 can also be utilized to optimize the characteristics of setting valve module 12.

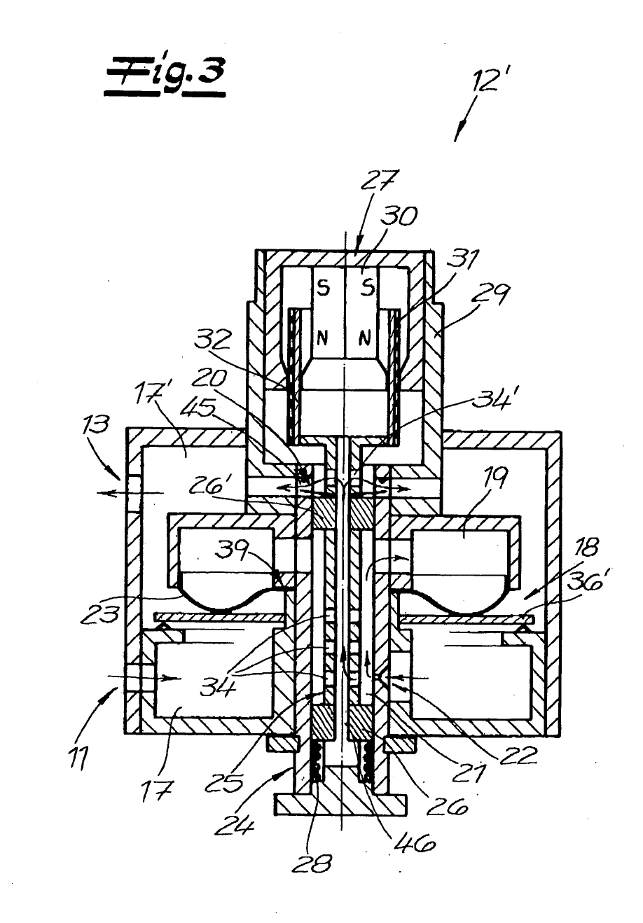

FIG. 3 shows an alternative embodiment of the controllable setting valve module 12′. Here, pilot valve 20 is configured not as a slide valve but rather as a poppet valve. Furthermore, main valve 18 has a rigid, ring-shaped disk as the valve element 36′, which disk is guided on slide housing 24 to move longitudinally. Pressure element 23 is elastically movable about a fixed clamp 39 on its inner circumference, and displaceably guided on its outer circumference, and sealed. Beyond that, the remainder of the configuration corresponds to valve module 12 shown in FIG. 2.

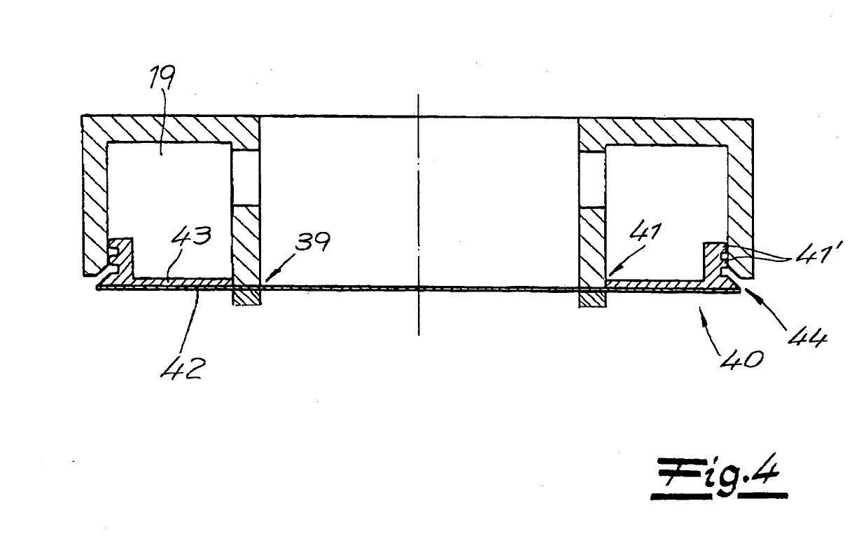

FIG. 4 shows another embodiment of the pressure element. Pressure element 23 is structured as a rubberized spring disk 40 having integrated sealing elements 41, 41′ on the inside and the outside. Rubberized spring disk 40 has a spring plate 42 and a rubberization 43 in the direction of pilot pressure chamber 19. Integrated sealing elements 41, 41′ on the inside and the outside are formed from rubberization 43, and a stop 44 is provided at the outer edge of rubberized spring disk 40. Rubberized spring disk 40 is attached by a fixed clamp 39, clamping it in place.

In order to have a positive influence on the characteristics when pilot valve 20 is configured as a slide valve, a variation of the shape of control edge 33 of guide segment 26′ on the outflow side and/or a special opening geometry of pilot valve opening 45 in slide housing 24 can be provided.

Accordingly, while only a few embodiments of the present invention have been shown and described, it is obvious that many changes and modifications may be made thereunto without departing from the spirit and scope of the invention.

What is claimed is:

1. A hydraulic vibration damper, comprising:
a cylinder that is filled with a damping medium, displaceably accommodates a working piston disposed on a piston rod, through which piston the damping medium can flow, and is divided by the working piston into a chamber on a piston rod side and a chamber away from the piston rod side;
an equalization chamber that is connected with the chamber away from the piston rod side, by way of a bottom valve;
a pressure channel connected with the chamber on the piston rod side; and
a controllable setting valve module, which is connected with the pressure channel by an inflow opening and with the equalization chamber by an outflow opening, said setting valve module having a valve chamber on an inflow side and a valve chamber on an outflow side;
a main valve separating the valve chambers; and
a pilot valve arrangement controlling the main valve, the pilot valve arrangement having a pilot pressure chamber and a pilot valve;
a pressure element to which pressure is applied by the pilot pressure chamber, said pressure element counteracting an opening movement of the main valve;
a slide housing around which the valve chamber on the inflow side and the valve chamber on the outflow side are disposed, said slide housing having a longitudinally moveable slide changing a flow cross-section of a pilot valve opening of the pilot valve, and said slide having inflow and outflow openings on a mantle side, as well as a passage channel that is open at its faces, for the purpose of pressure equalization;
a fluid chamber formed between the slide and the slide housing, said fluid chamber hydraulically connecting the valve chamber on the inflow side with the pilot pressure chamber; and
a plunger coil arrangement assigned to the slide as an actuator, such that a setting movement of the slide takes place counter to a force of a slide spring, and the pilot valve is closed in a non-powered state of the plunger coil arrangement;
wherein the pilot pressure chamber is hydraulically separated from the main valve, which opens in an outflow direction, and is connected with the valve chamber on the inflow side by way of a connection channel and at least one throttle point, and
wherein pressure that acts on the main valve by way of the pressure element is controlled by the pilot valve.

2. The vibration damper according to claim 1, wherein the plunger coil arrangement has a permanent magnet attached to a housing of the setting valve module, as well as a plunger coil directly connected with one end of the slide, by way of a slide carrier.

3. The vibration damper according to claim 1, wherein the slide is guided in the slide housing on a guide segment on the inflow side and a guide segment on the outflow side, and wherein the inflow openings on the mantle side are disposed between the guide segments, and wherein the guide segment on the outflow side interacts with the pilot valve opening and forms a part of the pilot valve.

4. The vibration damper according to claim 1, further comprising a valve spring disposed in the pilot pressure chamber, said valve spring acting on the pressure element and counteracting the opening movement of the main valve, together with the pressure prevailing in the pilot pressure chamber.

5. The vibration damper according to claim 1, wherein the main valve has a rigid plate or a spring disk arrangement formed from at least one elastic spring disk as a valve element.

6. The vibration damper according to claim 1, wherein the pressure element is configured as a ring piston, which is displaceably guided on its outer circumference and its inner circumference, and sealed.

7. The vibration damper according to claim 1, wherein the pressure element is elastically movable about a fixed clamp at its inner circumference, and displaceably guided at its outer circumference, and sealed.

8. The vibration damper according to claim 7, wherein the pressure element is structured as a rubberized spring disk with integrated sealing elements on an inside and on an outside.

9. The vibration damper according to claim 1, wherein the pressure element has at least one supporting edge or a supporting section, in order to guarantee a defined introduction of force from the pressure element to the main valve.
